(19) United States
(12) Patent Application Publication
(10) Pub. No.: US 2022/0370179 A1
(43) Pub. Date: Nov. 24, 2022

(54) Electric Toothbrush

(71) Applicant: Bruce Jackson, Sacramento, CA (US)

(72) Inventor: Bruce Jackson, Sacramento, CA (US)

(21) Appl. No.: 17/495,021

(22) Filed: Oct. 6, 2021

Related U.S. Application Data
(60) Provisional application No. 63/189,862, filed on May 18, 2021.

(51) Int. Cl. A61C 17/26; A61C 17/22

(52) U.S. Cl. CPC A61C 17/26; A61C 17/222; A61C 17/221; A61C 2204/002

(57) ABSTRACT

The present invention relates to an electric or motorized toothbrush. The toothbrush contains a brush head having bristles that rotate in either a clockwise or counterclockwise direction in a non-oscillating manner. An elongated handle contains a motor, rechargeable batteries and a rotatable shaft to rotate the bristles in a desired direction. The bristles are rotated using manual control buttons disposed on the handle. Typically, a clockwise rotation is performed for cleaning top teeth and a counterclockwise rotation is performed for cleaning bottom teeth. The toothbrush enables users to change the brush direction for top and bottom teeth without having to switch hands.

### CROSS-REFERENCE TO RELATED APPLICATION

The present application claims priority to, and the benefit of, U.S. Provisional Application No. 63/189,862, which was filed on May 18, 2021 and is incorporated herein by reference in its entirety.

### FIELD OF THE INVENTION

The present invention relates generally to the field of toothbrushes. More specifically, the present invention relates to an electric toothbrush that allows users to change brush directions per their needs and/or desires. The electric toothbrush comprises a handle portion, a head portion and a neck portion. The handle portion comprises a motor, a battery, a controller, a power button and rotational mode buttons. The head portion comprises a shaft. The neck portion comprises a brush attached to a shield. The head portion and the neck portion can be integrated into a single body structure or can be separate independent structures. The head portion is attached to the handle portion for operating the electronic toothbrush. A user can choose the brush rotation direction by using rotational mode buttons. The electric toothbrush allows users to effectively brush their teeth without switching their hands to change brush direction for top and bottom teeth. Accordingly, the present disclosure makes specific reference thereto. Nonetheless, it is to be appreciated that aspects of the present invention are also equally applicable to other like applications, devices and methods of manufacture.

### BACKGROUND

By way of background, dental hygiene is an important part of many individual's daily routine. Generally, individuals are advised to brush their teeth twice a day to maintain good oral hygiene. A variety of toothbrushes, including manual toothbrushes and electric toothbrushes, are available in the consumer market. Further, it is commonly known and accepted that electric toothbrushes typically clean teeth better than manual toothbrushes. Also, electric toothbrushes are easier to use and are able to complete the cleaning process in a shorter amount of time compared to manual toothbrushes. Typically, an electric toothbrush comprises a handle with a motor system and a brush head portion that allows users to oscillate the brush head portion for cleaning their teeth. The circular oscillation of the brush head oscillates the bristles which cleans a user's teeth easily and effectively.

Furthermore, the proper way to brush teeth is to brush downward away from the gums. Conventional electric toothbrushes oscillate and can push debris into the gums and can damage the gum line. A damaged gum line may cause infection and may reduce the capability of the gums to effectively hold teeth, thereby causing teeth to fall out. Additionally, with conventional electric toothbrushes users are often required to switch hands to change the brush oscillation direction for top and bottom teeth. At times, people may be uncomfortable in switching their hands while brushing teeth, or may be physically incapable of doing so.

Therefore, there exists a long-felt need in the art for an electric toothbrush that enables users to efficiently brush their teeth and maintain good oral hygiene. There is also a long-felt need in the art for an electric toothbrush that does not pushes debris into the gums of a user, and thus prevents damage to the gum line. Additionally, there is a long-felt need in the art for an electric toothbrush that ensures that the gum line remains healthy and that the gums are able to properly retain teeth. Moreover, there is a long felt need in the art for an electric toothbrush that does not require the user to switch hands while brushing to change the direction of the bristles, and that allows users to conveniently brush their top teeth and bottom teeth without the need to switch hands. Finally, there is a long-felt need in the art for an electric toothbrush that enhances the overall brushing experience for users.

The subject matter disclosed and claimed herein, in one embodiment thereof, comprises an electric toothbrush that is configured to change brush directions for an effective teeth cleaning. The electric toothbrush comprises a handle, a neck and a head, wherein the head includes bristles disposed on a rotatable bristle arm. The rotatable bristle arm is configured to rotate in either a clockwise direction or a counterclockwise direction in a non-oscillating manner, thereby allowing the bristles to rotate in a corresponding clockwise direction or counterclockwise direction. The rotation of the rotatable bristle arm and the bristles are controlled or reversed using control buttons disposed on the handle. Further, the rotatable bristle arm is connected to a rotatable shaft which is powered by a built-in motor.

In this manner, the novel electric toothbrush of the present invention accomplishes all of the forgoing objectives, and provides a relatively safe, convenient and efficient solution for brushing teeth without pushing debris into the gums and damaging the gum line. The electric toothbrush of the present invention is also user friendly, as it does not require users to switch hands while brushing top teeth and/or bottom teeth in order to change direction of the bristles. Also, the presence of mode selection buttons on the electric toothbrush allows users to change the direction of the bristles per their wants and/or needs.

### SUMMARY OF THE INVENTION

The following presents a simplified summary in order to provide a basic understanding of some aspects of the disclosed innovation. This summary is not an extensive overview, and it is not intended to identify key/critical elements or to delineate the scope thereof. Its sole purpose is to present some general concepts in a simplified form as a prelude to the more detailed description that is presented later.

The subject matter disclosed and claimed herein, in one embodiment thereof, comprises an improved electric toothbrush device. The electric toothbrush device is configured to change brush directions for an effective teeth cleaning. The toothbrush further comprises a handle, a neck and a head. The head is comprised of bristles disposed on a rotatable bristle arm, wherein the rotatable bristle arm is configured to rotate in either a clockwise direction or a counterclockwise direction in a non-oscillating manner allowing the bristles to rotate in a corresponding clockwise direction or counterclockwise direction. The rotation of the rotatable bristle arm and the bristles is controlled or reversed using control buttons disposed on the handle. Further, the rotatable bristle arm is connected to a rotatable shaft which is powered by a built-in motor. In a differing embodiment, the bristles may rotate or spin in a direction transverse to a longitudinal axis of the brush head. This non-oscillating, clockwise rotation of the bristles during use of the electric toothbrush device is used for cleaning top teeth and a reverse non-oscillating, counterclockwise rotation of the bristles is used for cleaning bottom teeth.

In a further embodiment of the present invention, a motorized toothbrush device is disclosed. The toothbrush device comprises an elongated handle having a cavity that houses a motor, a longitudinal shaft, a built-in battery and a control gear. The toothbrush device further comprises an integrated head and neck portion, wherein the longitudinal shaft extends from the elongated handle to the head to connect to a rotatable bristle arm. The rotatable bristle arm is disposed along a longitudinal axis of the toothbrush device, and a plurality of bristles are disposed on the rotatable bristle arm. The rotatable bristle arm rotates in a non-oscillating clockwise direction or a counterclockwise direction using the shaft which is powered via a motor, with the direction of rotation controlled via a manual control button disposed on an exterior surface of the handle.

In yet a further embodiment of the present invention, an electric toothbrush device with rotational brush head is disclosed. The electric toothbrush device comprises an elongated handle and a plurality of bristles extending from a rotatable bristle arm. The plurality of bristles are configured to move in a non-oscillating clockwise direction or a counterclockwise direction using a motor. Typically, the bristles are selectively rotated in a clockwise direction for cleaning top teeth and rotated in a counterclockwise direction for cleaning bottom teeth. The rotation of the plurality of bristles is reversed using control buttons disposed on the handle and the speed of the rotation is controlled using a control gear on the electric toothbrush device. The rotating bristles may also comprise a shield on a portion of the brush head for protecting a user's mouth from abrasions wherein the bristles rotate in a 360° non-oscillating manner. Therefore, the toothbrush enables users to change brush direction for top and bottom teeth without having to switch hands, and improves oral and gum health by providing brush direction control and by brushing debris away from the gum line.

To the accomplishment of the foregoing and related ends, certain illustrative aspects of the disclosed innovation are described herein in connection with the following description and the annexed drawings. These aspects are indicative, however, of but a few of the various ways in which the principles disclosed herein can be employed and are intended to include all such aspects and their equivalents. Other advantages and novel features will become apparent from the following detailed description when considered in conjunction with the drawings.

### BRIEF DESCRIPTION OF THE DRAWINGS

The description refers to provided drawings in which similar reference characters refer to similar parts throughout the different views, and in which:

FIG. 1 illustrates a perspective view of one potential embodiment of an electric toothbrush device of the present invention in accordance with the disclosed architecture;

FIG. 2 illustrates a perspective view disclosing the internal components housed in the elongated handle of one potential embodiment of an electric toothbrush device of the present invention in accordance with the disclosed architecture;

FIG. 3 illustrates a perspective view disclosing a head portion of one potential embodiment of an electric toothbrush device of the present invention in accordance with the disclosed architecture; and

FIG. 4 illustrates a close-up view disclosing the rotatable bristle arm disposed with a plurality of bristles of one potential embodiment of an electric toothbrush device of the present invention in accordance with the disclosed architecture.

### DETAILED DESCRIPTION OF THE INVENTION

The innovation is now described with reference to the drawings, wherein like reference numerals are used to refer to like elements throughout. In the following description, for purposes of explanation, numerous specific details are set forth in order to provide a thorough understanding thereof. It may be evident, however, that the innovation can be practiced without these specific details. In other instances, well-known structures and devices are shown in block diagram form in order to facilitate a description thereof. Various embodiments are discussed hereinafter. It should be noted that the figures are described only to facilitate the description of the embodiments. They are not intended as an exhaustive description of the invention and do not limit the scope of the invention. Additionally, an illustrated embodiment need not have all the aspects or advantages shown. Thus, in other embodiments, any of the features described herein from different embodiments may be combined.

As noted above, there exists a long-felt need in the art for an electric toothbrush that enables users to efficiently brush their teeth and maintain good oral hygiene. There is also a long-felt need in the art for an electric toothbrush that does not pushes debris into the gums, and prevents damage to the gum line to ensure the gum line remains healthy and able to properly hold teeth. Moreover, there is a long-felt need in the art for an electric toothbrush that does not require users to switch hands to change the direction of bristle movement for effectively brushing teeth. Further, there is a long-felt need in the art for an electric toothbrush that allows users to conveniently brush top teeth and bottom teeth without the need to switch hands. Finally, there is a long-felt need in the art for an electric toothbrush that enhances the user's overall brushing experience.

The present invention, in one embodiment, is comprised of a novel electric toothbrush device. The toothbrush device comprises an elongated handle having a cavity that houses a motor, a longitudinal shaft, a built-in battery and a control gear. The toothbrush device also comprises an integrated head and neck portion. The longitudinal shaft extends from the handle to the head to connect to a rotatable bristle arm wherein the rotatable bristle arm is disposed along the longitudinal axis of the toothbrush and includes a plurality of bristles. The rotatable bristle arm rotates in a non-oscillating clockwise direction or a counterclockwise direction and is powered via a motor. Further, the direction of rotation is controlled through a manual control button disposed on an exterior surface of the handle.

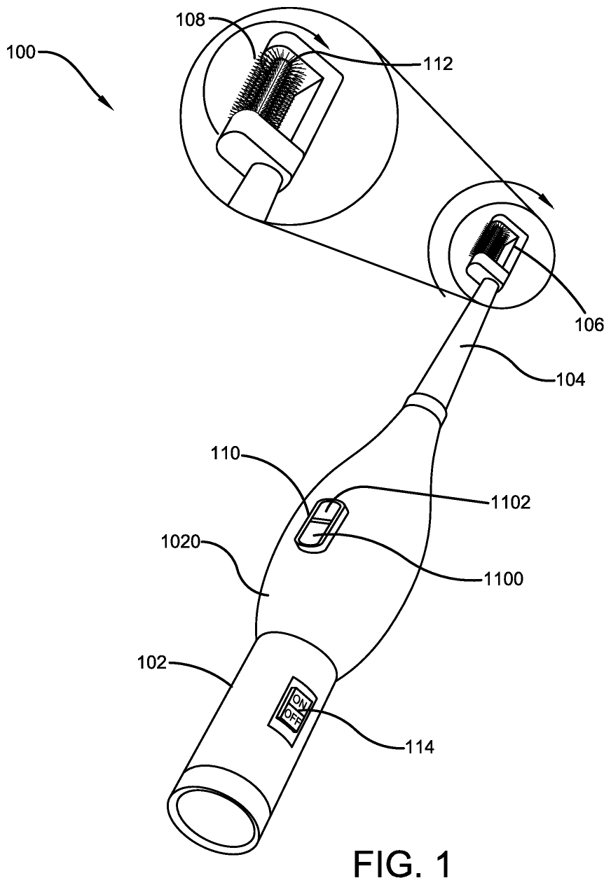

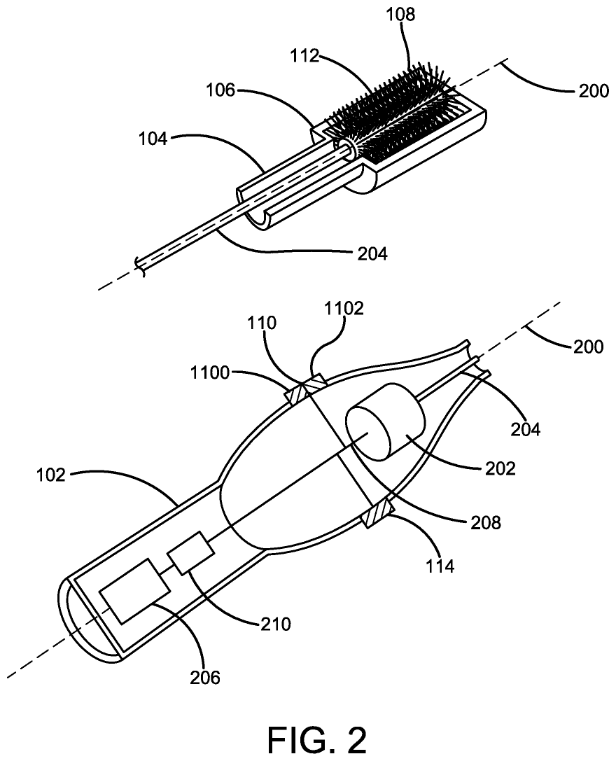

Referring initially to the drawings, FIG. 1 illustrates a perspective view of one potential embodiment of an electric toothbrush device 100 of the present invention in accordance with the disclosed architecture. The electric toothbrush device 100 of the present invention is a powered toothbrush comprising an elongated handle 102, a neck section 104 and a cylindrical head 106. The cylindrical head 106 is removably-attached to the neck section 104 or alternatively, the cylindrical head 106 can be permanently connected to the neck section 104 as one single, integrated piece. The elongated handle 102 can be cylindrical, square or tubular in shape, etc., or any other suitable shape as is known in the art. The elongated handle 102 can also be shaped to have an ergonomic grip to succinctly fit a user's hand, and/or texturing or other indentations or patterns for grip support. The elongated handle 102 is a cannulated or hollow housing for encasing a plurality of electronic components (described in FIG. 2), so as not to interfere with the operation of the electric toothbrush device 100.

The electric toothbrush device 100 further comprises a plurality of bristles 108 that are manufactured of nylon or any other suitable material as is known in the art. The plurality of bristles 108 are mounted on a rotatable bristle arm 112 that is coupled to a motor (not shown). The motor provides power for rotation of the rotatable bristle arm 112. The plurality of bristles 108 on the rotatable bristle arm 112 are configured to selectively rotate in a clockwise or a counterclockwise direction. A switch 110 on an exterior surface 1020 of the handle 102 is configured to manually control the rotation of the plurality of bristles 108. The switch 110 has a first control button 1100 that allows the plurality of bristles 108 to rotate in a clockwise direction, and a second control button 1102 that allows the plurality of bristles 108 to rotate in a counterclockwise direction.

In the present embodiment, upon activating the first control button 1100, the plurality of bristles 108 rotate or spin in a first continuous, non-oscillating rotational manner. Specifically, the plurality of bristles 108 are configured to spin or rotate in a complete and continuous manner, three hundred and sixty degrees (360°) in a clockwise direction. Thus, the plurality of bristles 108 continuously rotate in a clockwise direction and do not oscillate back and forth. Similarly, upon activating the second control button 1102, the plurality of bristles 108 are configured to spin or rotate in a complete and continuous manner, three hundred and sixty degrees (360°) in a counterclockwise direction. Thus, the plurality of bristles 108 continuously rotate in a counterclockwise direction and do not oscillate back and forth.

The rotation of the plurality of bristles 108 in either the clockwise or counterclockwise direction allows the effective cleaning of both the top teeth and the bottom teeth of a user. Further, the plurality of bristles 108 is typically disposed perpendicular to the rotatable bristle arm 112, allowing a complete cleaning of the user's teeth. Alternatively, the plurality of bristles 108 can be disposed in a spiral angle to the rotatable bristle arm 112, or disposed in any other suitable angle or position to the rotatable bristle arm 112 as is known in the art. The plurality of bristles 108 are made of nylon and/or polyester and are adapted for cleaning teeth and removing plaque without damaging the gums. The continual rolling or rotating motion of the plurality of brushing bristles 108 brushes the tooth surface and the gumline so as to efficiently and effectively clean a user's teeth.

The head 106 is removably-attached or integrated to the neck portion 104 as a single piece. Typically, the neck 104 is secured to the handle 102 using a threaded integrated fastener, or any other suitable fastener as is known in the art. The head 106 allows rotation of the plurality of bristles 108 without allowing the plurality of bristles 108 to lose their shape. Further, the continual rolling motion of the plurality of bristles 108 in a desired rotational direction efficiently and effectively cleans a user's teeth, and reduces the amount of brushing time needed in comparison with a conventional electric toothbrush.

The handle 102 further comprises a power button 114 for manually turning ON and OFF the electric toothbrush device 100. The power button 114 is configured to provide electric power through a built-in battery 206 connected to a motor 202 which consequently rotates the plurality of bristles 108 disposed on the rotatable bristle arm 112.

FIG. 2 illustrates a perspective view disclosing the internal components housed in the elongated handle 102 of one potential embodiment of an electric toothbrush device 100 of the present invention in accordance with the disclosed architecture. Specifically, the elongated handle 102 extends along its longitudinal axis 200. Typically, the handle 102 is cannulated or hollow and houses the electronic components of the electric toothbrush device 100. A miniature motor 202 is housed within the handle 102 and is coupled to a shaft 204 connecting the motor 202 and rotatable bristle arm 112. The shaft 204 passes through the handle 102 and the neck portion 104 and allows the rotatable bristle arm 112 to rotate in a clockwise or a counterclockwise direction. In cases, where the head portion 106 is removably secured to the neck portion 104, the rotatable bristle arm 112 is securely connected to the neck portion 104 when the head 106 is secured to the neck portion 104 along the longitudinal axis 200 of the electric toothbrush device 100.

A built-in battery 206 such as AAA or Li-Ion batteries, or any other suitable batteries as are known in the art, are housed within the handle 102 to provide power to the motor 202 for rotating the shaft 204. Thus, when the power button 114 disposed on the exterior surface 1020 of the elongated handle 102 is manually activated, power is provided by the battery 206 to the motor 202. The motor 202, the shaft 204 and the battery 206 are coupled together through a wired circuit 208.

The motor 202 is coupled to switch 110, and based on the manual actuation of control buttons 1100 or 1102, the plurality of bristles 108 rotate in a clockwise or a counterclockwise direction. In one embodiment, the rotational speed and time for rotation is provided by the motor 202 as predefined by a user. In the present embodiment, a speed adjuster module or control gear 210 is positioned within the housing and allows a user to adjust (i.e., increase/decrease) the rotational speed and time for rotation of the plurality of bristles 108. The rotational speed and time for rotation can typically be adjusted using the manual control buttons 1100, 1102 or there can be a separate speed and time control button present on the exterior surface of the handle 102. Also, the control gear 210 can be of any shape, size and ratio such that the rotational speed of the shaft 204 is effectively controlled. Furthermore, the control gear 210 can include bevel gears or any other suitable mechanism as is known in the art for controlling rotational speed and time for rotation.

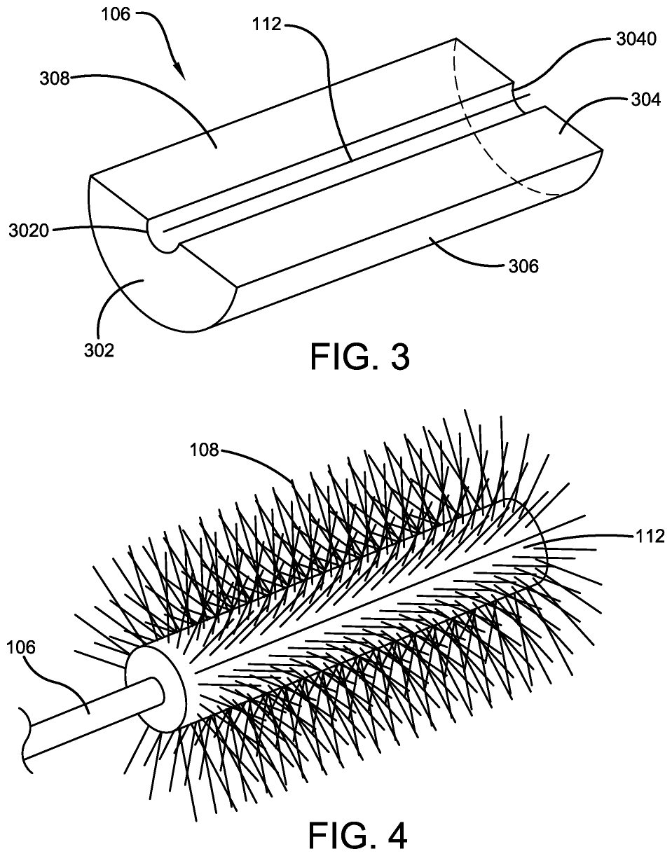

FIG. 3 illustrates a perspective view disclosing a head portion 106 of one potential embodiment of an electric toothbrush device 100 of the present invention in accordance with the disclosed architecture. The head portion 106 is used for housing the plurality of brushing bristles 108, wherein the plurality of brushing bristles 108 are disposed along a length of a rotatable bristle arm 112. The head 106 typically comprises a semi-cylindrical bottom section 306, two opposing side walls 302, 304 and a top open area 308 which houses the plurality of brushing bristles used for cleaning teeth. The head 106 is of suitable shape and size and has enough depth to allow the plurality of brushing bristles to rotate without touching the head 106.

A first opposing side wall 302 comprises a cut-out 3020 and a second opposing side wall 304 comprises a corresponding cut-out 3040 which allows the rotatable bristle arm 112 to be positioned securely along the head 106. The rotatable bristle arm 112 easily rotates within the cut-outs 3020, 3040, which then rotates the plurality of brushing bristles in a clockwise or a counterclockwise direction. The rotatable bristle arm 112 can be fixedly-attached or removably secured to the head portion 106 as per the embodiments of the present invention.

It should be noted that the head portion 106 is of a suitable size, shape, and dimension as to fit in a user's mouth and allow the plurality of brushing bristles to engage substantially with all surfaces of a user's teeth. Further, the head portion 106 allows the smooth rotation of the plurality of bristles to provide an effective teeth cleaning.

FIG. 4 illustrates a close-up view disclosing the rotatable bristle arm 112 disposed with a plurality of bristles 108 of one potential embodiment of an electric toothbrush device 100 of the present invention in accordance with the disclosed architecture. The plurality of brushing bristles 108 are manufactured of nylon, polyester, or any other suitable material as is known in the art that effectively cleans teeth. The rotatable bristle arm 112 is configured to rotate in both a clockwise direction and a counterclockwise direction, thereby allowing the plurality of brushing bristles 108 to clean both top teeth and bottom teeth effectively.

The plurality of brushing bristles 108 can also be disposed in any suitable orientation that is effective for cleaning. For example, the plurality of bristles 108 can be positioned in crisscross form, interlocking form, disposed perpendicular to, or oriented at any other suitable angle or position to the rotatable bristle arm 112 as is known in the art. Further, the rotatable bristle arm 112 does not oscillate, but rotates in a particular direction allowing a user to easily actuate the rotatable bristle arm 112 to rotate in one direction to brush the upper set of teeth, while actuating the rotatable bristle arm 112 to rotate in an opposite direction to brush the lower set of teeth.

It should be noted that the rotation of the plurality of bristles 108 is transverse to the longitudinal axis of the electric toothbrush device 100 allowing both movement towards the gumline and away from the gumline. When rotated in a particular direction (clockwise or counterclockwise), the same bristles rotate in a 360° manner for a specified period of time. The rotating bristles 108 polish the teeth and also clean or brush deep within the teeth or between the teeth, removing plaque, tarter or other build up, that conventional toothbrushes are unable to reach.

Various embodiments may be configured such that the head portion of the electric toothbrush device 100 is replaceable, by disconnecting the head from the handle or neck portion and replacing the head with a new or different one. The electric toothbrush device 100 can be powered by virtually any source of power, including, for example, via one or more replaceable or integrated DC batteries, or any other suitable source of power as is known in the art.

Certain terms are used throughout the following description and claims to refer to particular features or components. As one skilled in the art will appreciate, different persons may refer to the same feature or component by different names. This document does not intend to distinguish between components or features that differ in name but not structure or function. As used herein “electric toothbrush device”, “electronic toothbrush device”, “toothbrush device”, and “toothbrush” are interchangeable and refer to the electric toothbrush device 100 of the present invention.

Notwithstanding the forgoing, the electric toothbrush device 100 of the present invention can be of any suitable size and configuration as is known in the art without affecting the overall concept of the invention, provided that it accomplishes the above-stated objectives. One of ordinary skill in the art will appreciate that the size, configuration, and material of the electric toothbrush device 100 as shown in FIGS. 1-4 is for illustrative purposes only, and that many other sizes and shapes of the electric toothbrush device 100 are well within the scope of the present disclosure. Although the dimensions of the electric toothbrush device 100 are important design parameters for user convenience, the electric toothbrush device 100 may be of any size that ensures optimal performance during use and/or that suits the user's needs and/or preferences.

Various modifications and additions can be made to the exemplary embodiments discussed without departing from the scope of the present invention. While the embodiments described above refer to particular features, the scope of this invention also includes embodiments having different combinations of features and embodiments that do not include all of the described features. Accordingly, the scope of the present invention is intended to embrace all such alternatives, modifications, and variations as fall within the scope of the claims, together with all equivalents thereof.

What has been described above includes examples of the claimed subject matter. It is, of course, not possible to describe every conceivable combination of components or methodologies for purposes of describing the claimed subject matter, but one of ordinary skill in the art may recognize that many further combinations and permutations of the claimed subject matter are possible. Accordingly, the claimed subject matter is intended to embrace all such alterations, modifications and variations that fall within the spirit and scope of the appended claims. Furthermore, to the extent that the term “includes” is used in either the detailed description or the claims, such term is intended to be inclusive in a manner similar to the term “comprising” as “comprising” is interpreted when employed as a transitional word in a claim.

What is claimed is:

1. An electric toothbrush device that allows a user to change a direction of bristle movement for effectively brushing teeth, the electric toothbrush device comprising:
a hollow elongated handle for housing a plurality of electronic components;
a neck section;
a cylindrical head;
a rotatable bristle arm comprising a plurality of bristles; and
a motor coupled to the rotatable bristle arm for powering rotation of the rotatable bristle arm, wherein the plurality of bristles disposed on the rotatable bristle arm are configured to selectively rotate in a clockwise or a counterclockwise direction.

2. The electric toothbrush device of claim 1, wherein the cylindrical head is removably attached to the neck section.

3. The electric toothbrush device of claim 1, wherein the cylindrical head is permanently connected to the neck section as one integrated component.

4. The electric toothbrush device of claim 1, wherein the hollow elongated handle is ergonomic in shape.

5. The electric toothbrush device of claim 1, wherein the plurality of bristles are disposed perpendicular to the rotatable bristle arm.

6. The electric toothbrush device of claim 1, wherein the plurality of bristles are disposed in a spiral angle to the rotatable bristle arm.

7. The electric toothbrush device of claim 1 further comprising a switch on an exterior surface of the hollow elongated handle for controlling rotation of the plurality of bristles.

8. The electric toothbrush device of claim 7, wherein the switch comprises a first control button that allows the plurality of bristles to rotate in a clockwise direction.

9. The electric toothbrush device of claim 8, wherein the switch comprises a second control button that allows the plurality of bristles to rotate in a counterclockwise direction.

10. The electric toothbrush device of claim 9 further comprising a power button for manually turning on and off the electric toothbrush device.

11. The electric toothbrush device of claim 10, wherein the power button is configured to control power provided by a built-in battery connected to the motor.

12. An electric toothbrush device that allows a user to change a direction of bristle movement for effectively brushing teeth, the electric toothbrush comprising:
a hollow elongated handle;
a neck section;
a cylindrical head;
a rotatable bristle arm comprising a plurality of bristles; and
a motor housed within the hollow elongated handle and coupled to the rotatable bristle arm for powering rotation of the rotatable bristle arm, wherein the motor is coupled to a shaft which passes through the hollow elongated handle and the neck section and is secured to the rotatable bristle arm for rotation, and further wherein the shaft allows the rotatable bristle arm to rotate in a clockwise or a counterclockwise direction.

13. The electric toothbrush device of claim 12, wherein the hollow elongated handle extends along a longitudinal axis.

14. The electric toothbrush device of claim 12 further comprising a built-in battery housed within the hollow elongated handle to provide power to the motor.

15. The electric toothbrush device of claim 14, wherein the built-in battery, the shaft, and the motor are coupled together via a wired circuit.

16. The electric toothbrush device of claim 15 further comprising a control gear component positioned within the hollow elongated handle to control rotational speed and time for rotation of the rotatable bristle arm.

17. An electric toothbrush device that allows a user to change a direction of bristle movement for effectively brushing teeth, the electric toothbrush comprising:
a hollow elongated handle;
a neck section;
a cylindrical head;
a rotatable bristle arm comprising a plurality of bristles;
a motor housed within the hollow elongated handle and coupled to the rotatable bristle arm for powering rotation of the rotatable bristle arm;
a power button for manually turning on and off the motor;
a switch on an exterior surface of the hollow elongated handle for controlling rotation of the plurality of bristles, wherein the switch comprises a first control button that allows the plurality of bristles to rotate in a clockwise direction and a second control button that allows the plurality of bristles to rotate in a counterclockwise direction, and further wherein the motor is coupled to a shaft which passes through the hollow elongated handle and the neck section and is secured to the rotatable bristle arm for rotation.

18. The electric toothbrush device of claim 17, wherein the cylindrical head comprises a bottom section, a first and a second opposing side wall, and a top open area.

19. The electric toothbrush device of claim 18, wherein the top open area of the cylindrical head houses the rotatable bristle arm and the plurality of bristles.

20. The electric toothbrush device of claim 19, wherein the first opposing side wall comprises a first cut-out and the second opposing side wall comprises a second cut-out, and further wherein the rotatable bristle arm rotates within the first and the second cut-outs.
